(19) United States
(12) Patent Application Publication
(10) Pub. No.: US 2011/0026278 A1
(43) Pub. Date: Feb. 3, 2011

(54) CURRENT-CONTROLLED SELF-OSCILLATING FLYBACK CONVERTER WITH TWO TRANSISTORS

(75) Inventor: Xiangyang Yin, Guangzhou (CN)

Correspondence Address: Ballard Spahr LLP, SUITE 1000, 999 PEACHTREE STREET, ATLANTA, GA, 30309-3915, US

(73) Assignee: MORNSUN GUANGZHOU SCIENCE & TECHNOLOGY LTD., Guangzhou (CN)

(21) Appl. No.: 12/935,229

(22) PCT Filed: Jan. 4, 2009
(86) PCT No.: PCT/CN09/70007

§ 371 Date: Sep. 28, 2010

(30) Foreign Application Priority Data
Apr. 8, 2008 (CN) 200810027284.8

(51) Int. Cl. H02M 3/335

(52) U.S. Cl. 363/21.15

(57) ABSTRACT

A current controlled self-oscillating flyback converter with two transistors. The converter includes a soft start circuit, a MOS transistor, a transformer, a pulse frequency modulation circuit, a reference amplification circuit, an isolation optical coupler and a voltage-stabilized output circuit. The pulse frequency modulation circuit includes a transistor, a third resistor, a capacitor connected in parallel with the third resistor and a fourth resistor. The pulse frequency modulation circuit further includes a transistor current control circuit. The control circuit is connected between the MOS transistor and the transistor.

This application claims the priority to Chinese Patent Application no. 200810027284.8, filed with the Chinese Patent Office on Apr. 8, 2008 and entitled “Current Controlled Ring Choke Converter With Dual-Transistor”, which is hereby incorporated by reference in its entirety.

### FIELD OF THE INVENTION

The present invention relates to a ring choke converter applicable to a low power DC-DC conversion power source and in particular to a current controlled ring choke converter with dual-transistor at an input terminal.

### BACKGROUND OF THE INVENTION

FIG. 1 illustrates a circuit principle block diagram of a Ring Choke Converter (RCC) in the prior art. The RCC generally includes a filter part, a soft starter part, an MOS transistor, a transformer, a Pulse Frequency Modulation (PFM) part, a reference amplifier part, an isolating optical coupler and a regulated voltage output loop part. Input electric quantity is connected with the output loop part through the transformer, and the soft starter part is connected with the gate of the MOS transistor which is also connected to the PFM. The reference amplifier part and the isolating optical coupler are connected between the PFM and the regulated voltage output loop part to form a voltage negative feedback loop.

FIG. 2 illustrates a ring choke converter of a low power DC-DC conversion power source commonly used in the industry at present, where the soft starter part is generally consisted of resistors R1, R7 and R8 connected in series and a capacitor C9 connected in parallel across the resistors R7 and R8.

The PFM includes an NPN type transistor TR2, capacitors C1 and C2, resistors R2, R3 and R4, a freewheeling diode D3 and a feedback winding P2. An input voltage is connected to the dotted terminal of a primary winding P1. The undotted terminal of the primary winding P1 is connected to the drain of an MOS transistor TR1. The source of the MOS transistor TR1 is respectively grounded through the resistor R4 and connected with the base of the transistor TR2 through the bias resistor R3 across which the capacitor C2 is connected in parallel. The transistor TR2 has the collector connected with the gate of the MOS transistor TR1 and the emitter grounded. The dotted terminal of the feedback winding P2 is connected with the gate of the MOS transistor TR1 through the capacitor C1 and the resistor R2. The freewheeling diode D3 has its cathode connected with the dotted terminal of the feedback winding P2 and the anode grounded in one branch and connected in another branch with an optical coupler OC1 through a capacitor C51. The input voltage is connected in another branch with the gate of the MOS transistor TR1 through the soft starter part. The reference amplifier part is consisted of a regulator Adj to input a sampled voltage of the output loop part as a negative feedback signal to the base of the transistor TR2 of the PFM through the optical coupler OC1 so as to form the voltage negative feedback loop. The regulated voltage output loop part is generally consisted of a secondary winding P3 of a transformer T1, a rectifier diode D1 and a filter capacitor C3 in connection.

As the MOS transistor TR1 is switched off, charges accumulated in the internal junction capacitor Ciss have to pass the capacitor C1, the resistor R2 and the feedback winding P2 of the transformer T1 until being grounded to thereby form a discharge loop. Due to a large discharge time constant, a switch-off wave shape is distorted. The process for switching off MOS transistor TR1 has to be lost a considerable power, thus degrading the overall efficiency of a product.

When the circuit operates in the output short-circuit status, very large instantaneous short-circuit current gives rise to relatively high voltage at the point Vg1. If the MOS transistor TR1 is enhanced in conductivity, then both the drain current Id and the voltage drop across R4 is increased, so that the transistor TR2 is enhanced in conductivity and then the potential at the point Vg1 is dropped and TR1 quits gradually the saturation status. The conduction inner-resistance of the MOS transistor TR1 is increased, and the drain current Id thereof is dropped. However, since the transistor TR2 operates in the amplifier status, the gate voltage Vg1 of the MOS transistor TR1 will not be dropped too low, and the MOS transistor TR1 will not be cutoff reliably, but relatively large drain current Id may occur, thus resulting in a considerable short-circuit power consumption.

When the base voltage of the transistor TR2 is below (0.7V+V_{R3}) (where V_{R3} denotes the voltage across the resistor R3), the TR2 is cutoff and the potential at the point Vg1 is increased again, so that again the MOS transistor TR1 is enhanced in conductivity and the drain current Id of the MOS transistor TR1 is increased. This loop will be repeated in this manner, until self-excited oscillation at high frequency occurs at the circuit and switching loss of the MOS transistor is increased. As can be apparent from the equation: Short-circuit power Ps=Input voltage Vin*Input short-circuit current Ii (here Ii approximates the drain current Id of the MOS transistor TR1), the short-circuit power Ps has a certain proportional relationship with and is increased with the input voltage Vin. Assumed there is a product with nominal input voltage of 5 VDC, output power of 3 W and input voltage ranging from 4.5 to 9 VDC. In the case of short-circuit, if the input voltage is 5 VDC and the short-circuit current is 0.34 A, then the short-circuit power Ps=5*0.34=1.7 W. At this time, if the input voltage is 9 VDC and the short-circuit current is 0.27 A, then the short-circuit power Ps=9*0.27=2.43 W, apparently increasing the short-circuit power consumption. On the other hand, when the potential at the point Vg1 is higher than that at the point V1, current will be reversed to flow to a preceding circuit, thus disturbing the preceding circuit. Also certain discreteness in a transformer winding process and non-flattened primary windings may result in high leak inductances of the primary and secondary windings, thus also increasing sharply the short-circuit power consumption.

In the event of the foregoing circuit applying input voltage in a wide range, especially circuits with an input voltage variation ratio ranging from 2:1 to 4:1 or higher among micro-power circuits with power below 10 W, some tough problems arise in practical applications. General drawbacks lie in distortion of a wave shape arising when the MOS transistor TR1 is cutoff, thus increasing the switching loss of the MOS transistor TR1, degrading the overall efficiency of the product and increasing the noise of the product; large short-circuit power being increased with the input voltage; increasing a difference between peaks of the drain-source voltage Vds of the MOS transistor TR1; and operating frequency varying with the input voltage and the output load, resulting in difficulty with a Electro Magnetic Interference (EMI) design, and oscillation easily arising during no-load operation, thus making the output voltage instable.

### SUMMARY OF THE INVENTION

An object of the invention is to provide a current controlled ring choke converter with dual-transistor, which can reduce a switching loss and a short-circuit power consumption and improve the load/no-load performance of an overall product.

The invention provides a current controlled ring choke converter with dual-transistor, which includes a soft startup part, an MOS transistor TR1, a transformer T1, a Pulse Frequency Modulation, PFM, part, a reference amplification part, an isolating optical coupler OC1 and a regulated voltage output loop part, wherein:

input electric quantity is connected with the output loop part through the transistor T1;

the soft startup part is connected with the gate of the MOS transistor TR1;

the gate of the MOS transistor TR1 is further connected with the Pulse Frequency Modulation, PFM, part;

the reference amplification part and the isolating optical couple OC1 are connected between the Pulse Frequency Modulation, PFM, part and the regulated voltage output loop part to form a voltage negative feedback loop; and

the Pulse Frequency Modulation, PFM, part generally includes a transistor TR2, a resistor R3, a capacitor C2 and a resistor R4, the base of the transistor TR2 is connected with the source of the MOS transistor TR1 through the resistor R3 and the capacitor C2 connected in parallel, and the source of the MOS transistor TR1 is grounded through the resistor R4,

the Pulse Frequency Modulation, PFM, part is further provided with a transistor current control circuit connected between the MOS transistor TR1 and the transistor TR2 to enable a self-excited oscillation output of dual-transistor current control at an input terminal.

Preferably, the transistor current control circuit includes a transistor TR3 and a resistor R36;

the transistor TR3 has an emitter connected with the gate of the MOS transistor TR1, a base connected in one branch with the gate of the MOS transistor TR1 through the bias resistor R36 and in another branch with the collector of the transistor TR2, and a collector connected with the base of the transistor TR2;

the base of the transistor TR2 is connected with the source of the MOS transistor TR1 through the bias resistor R3; and

the source of the MOS transistor TR1 is grounded through the resistor R4.

Preferably, the transistor current control circuit includes a transistor TR3 and a resistor R36;

the transistor TR3 has an emitter connected with the gate of the MOS transistor TR1, a base connected in one branch with the gate of the MOS transistor TR1 through the bias resistor R36 and in another branch with the collector of the transistor TR2, and a collector connected with the source of the MOS transistor TR1;

the source of the MOS transistor TR1 is connected with the base of the transistor TR2 through the bias resistor R3; and

the source of the MOS transistor TR1 is grounded through the resistor R4.

Preferably, the transistor current control circuit includes a transistor TR3, a resistor R36 and a resistor R27;

the transistor TR3 has an emitter connected with the gate of the MOS transistor TR1, a base connected in one branch with the gate of the MOS transistor TR1 through the bias resistor R36 and in another branch with the collector of the transistor TR2 through the bias resistor R27, and a collector connected with the source of the MOS transistor TR1;

the source of the MOS transistor TR1 is connected with the base of the transistor TR2 through the bias resistor R3; and

the source of the MOS transistor TR1 is grounded through the resistor R4.

Preferably, a current mutual inductor Si and a flywheel diode D5 are connected between the source of the MOS transistor TR1 and the resistor R4;

a dotted terminal of a primary winding of the current mutual inductor Si is connected with the source of the MOS transistor TR1;

a dotted terminal of a secondary winding of the current mutual inductor Si is connected with the anode of the diode D5;

the cathode of the diode D5 is connected with the resistor R4; two undotted terminals of the current mutual inductor Si are grounded.

Preferably, a capacitor C34 is connected in parallel across the bias resistor R36, and the capacitor C2 is connected in parallel across the bias resistor R3.

Preferably, the MOS transistor TR1 is of the N channel type, the transistor TR2 is of the NPN type, and the transistor TR3 is of the PNP type.

Preferably, the gate of the MOS transistor TR1 is connected with a regulated voltage diode Z1; and

the regulated voltage diode Z1 has a cathode connected with the gate of the MOS transistor TR1 and an anode grounded.

Preferably, the soft restart circuit is consisted of a resistor R1, a resistor R8, a capacitor C9 and a diode D2;

the input terminal VIN connected in series with the resistor R1 is grounded in one branch through the capacitor C9 and connected in another branch with the anode of the diode D2; and

the cathode of the diode D2 is grounded in one branch through the resistor R8 and connected in another branch with the gate of the MOS transistor TR1.

Preferably, the diode D2 is a fast recovery diode.

The periods of time to switch off the MOS transistor TR1 can be shorten greatly due to the dual-transistor pulse frequency modulation at the input terminal according to the invention, thereby improving the overall efficiency of the product. Also the short-circuit power of the product can be reduced significantly due to the transistor TR3 of which the discharge loop of the internal junction capacitor Ciss of the MOS transistor TR1q is consisted.

Advantages of the invention over the prior art lie in that the current controlled ring choke converter with dual-transistor can operate efficiently and without being loaded while ensuring stable output voltage; the no-load power consumption can be made very low on the order of 10⁻¹ W; the short-circuit power can be very low, which is substantially unchanged regardless of varying input voltage; continuous short-circuit protection can be provided; and a dynamic response can be made rapidly

### BRIEF DESCRIPTION OF THE DRAWINGS

FIG. 1 is a circuit principle block diagram in the prior art;

FIG. 2 is a circuit principle diagram in the prior art;

FIG. 3 is a circuit principle diagram according to a first embodiment of the invention;

FIG. 4 is a characteristic graph of the nominal input voltage efficiency vs. the output load of a circuit according to the invention;

FIG. 5 is a wave shape diagram of the gate voltage (Vg1) when a MOS transistor in the prior art operates in the stable status and nominal full load;

FIG. 6 is a wave shape diagram of the gate voltage (Vg1) when a MOS transistor according to a first embodiment of the invention operates in the stable status and nominal full load;

FIG. 7 is a wave shape diagram of the drain voltage (Vds) when the MOS transistor in the prior art operates in the stable status and nominal full load;

FIG. 8 is a wave shape diagram of the drain voltage (Vds) when the MOS transistor according to a first embodiment of the invention operates in the stable status and nominal full load;

FIG. 9 is a circuit principle diagram according to a second embodiment of the invention;

FIG. 10 is a circuit principle diagram according to a third embodiment of the invention; and

FIG. 11 is a circuit principle diagram according to a fourth embodiment of the invention.

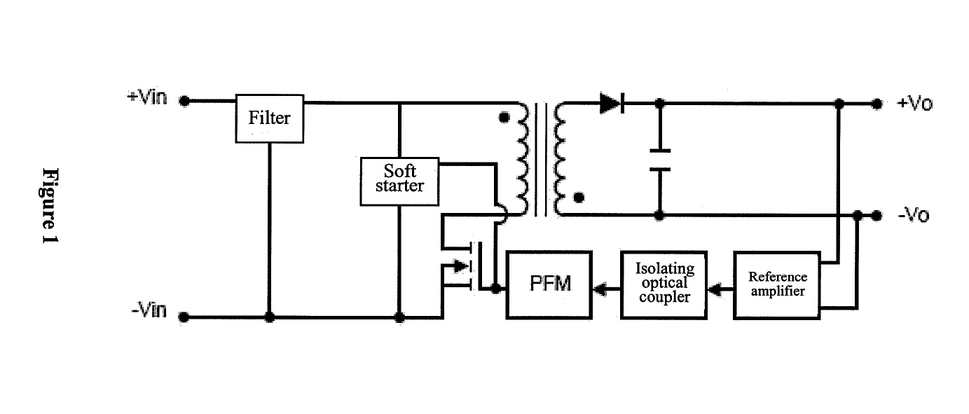

### DETAILED DESCRIPTION OF THE INVENTION

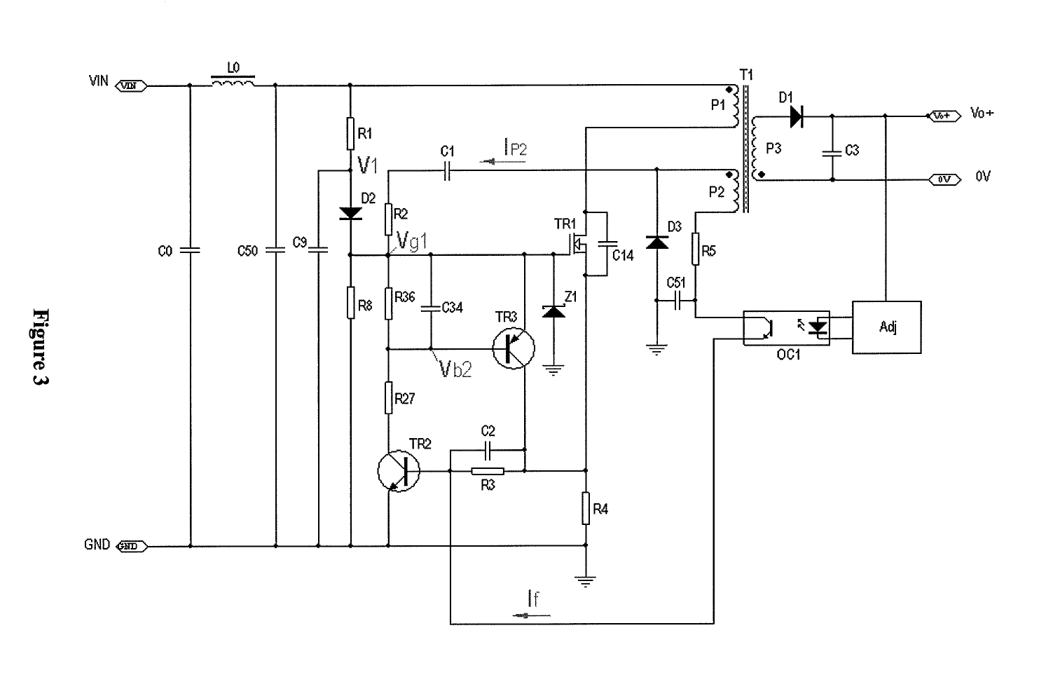

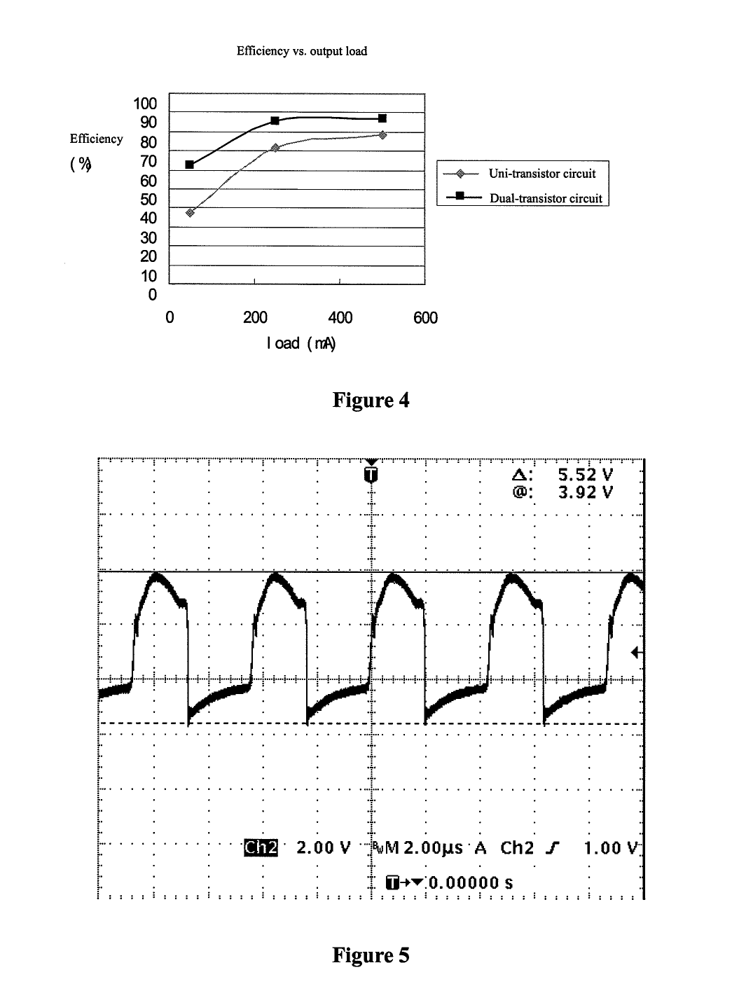

As illustrated in FIG. 3, the invention provides a current controlled ring choke converter with dual-transistor, which generally includes a soft starter part, an MOS transistor TR1, a transformer T1, a PFM, a reference amplifier part, an isolating optical coupler and a regulated voltage output loop part.

Particularly, the PFM generally includes an NPN type transistor TR2, a PNP type transistor TR3, capacitors C1 and C2, resistors R2, R3, R4, R27, R36, C34, a regulated voltage diode Z1, a freewheeling diode D3 and a feedback winding P2.

An input voltage is connected in one branch with the gate of the MOS transistor TR1 via the soft starter part and in another branch with the dotted terminal of a primary winding P1.

The undotted terminal of the primary winding P1 is connected with the drain of the MOS transistor TR1. The source of the MOS transistor TR1 is respectively grounded through the resistor R4 and connected with the base of the transistor TR2 through the bias resistor R3 across which the capacitor C2 is connected in parallel. The transistor TR2 has a collector connected with the resistor R27 and an emitter grounded.

The dotted terminal of the feedback winding P2 is connected with the gate of the MOS transistor TR1 through the capacitor C1 and the resistor R2.

The transistor TR3 has an emitter connected with the gate of the MOS transistor TR1; a collector connected with the source of the MOS transistor TR1; and a base connected in one branch with the gate of the MOS transistor TR1 through the bias resistor R36 and the capacitor C34 and in another branch in series with the bias resistor R27 and then connect with the collector of the transistor TR2.

The freewheeling diode D3 has a cathode connected with the dotted terminal of the feedback winding P2 and an anode grounded in one branch and connected in another branch with an optical coupler OC1 through a capacitor C51.

Moreover, the regulated voltage diode Z1 is connected with the gate of the MOS transistor TR1.

The regulated voltage diode Z1 has a cathode connected with the gate of the MOS transistor TR1 and an anode grounded.

The regulated voltage diode Z1 functions to limit the gate voltage of the MOS transistor TR1 with a high voltage input thereto and also can improve the phenomenon of no-load oscillation.

The regulated voltage output loop part is generally consisted of a secondary winding P3 of the transformer T1, a flywheel diode D1 and a filter capacitor C3 in connection.

The reference amplifier part is consisted of a regulator Adj to input a sampled voltage of the output loop part as a negative feedback signal to the base of the transistor TR2 of the pulse frequency modulation part through the optical coupler OC1 so as to form a voltage negative feedback loop.

The invention operates under the following principle: voltage applied to the input terminal VIN is supplied to the gate of the MOS transistor TR1 through the resistor R1 and the diode D2 to charge the internal junction capacitor Ciss of the MOS transistor TR1.

When the gate voltage Vg1 of the MOS transistor TR1 reaches the on-state voltage Vth, the MOS transistor TR1 is switched on. Then the self-induced electrical potential with a positive upper side and a negative lower side arises at the primary winding P1 of the transformer T1.

Since the regulating filter circuit connected with the secondary winding P3 of the transformer T1 is cutoff due to the reversed inducted electrical potential, electrical energy is stored as magnetic energy inside the primary winding P1 of the transformer T1. Since the period of time for positive feedback avalanche is too short, the capacitor C1 does not have time to charge. Meanwhile the induced electrical potential with a positive upper side and a negative lower side also arises at the feedback winding P2 of the transformer T1 due to mutual inductance and is applied to the gate of the MOS transistor TR1 through a positive feedback loop consisted of the capacitor C1 and the resistor R2 to further increase the gate voltage Vg1, thus making the MOS transistor TR1 saturate rapidly.

After the MOS transistor TR1 is saturated, the capacitor C1 is charged by the inducted voltage across the feedback winding P2, and the potential difference across the capacitor C1 is increased with progression of charging the capacitor C1. Then the gate voltage Vg1 of the MOS transistor TR1 is dropped, thus making the MOS transistor TR1 quit gradually the saturation status.

After the MOS transistor TR1 quits the saturation state, the inner-resistance thereof is increased and consequently the drain current Id thereof is further dropped; and since the current in an inductor can not be mutated, the inducted electrical potential of the respective windings of the transformer T1 is reversed.

Also during the process of saturating and conducting the MOS transistor TR1, both the drain current Id flowing through the primary winding P1 and the MOS transistor TR1 and the voltage drop across the resistor R4 is increased over time. When the voltage reaches (0.7V+V_{R3}) (where V_{R3} denotes the voltage across the resistor R3), the transistor TR2 is switched on, and the base voltage of the transistor TR3 is dropped to thereby switch on the transistor TR3. The collector current of the transistor TR3 is increased, and the transistor TR2 is enhanced in conductivity. This loop is repeated in this manner, until the transistors TR2 and TR3 are saturated. Also since the transistor TR3 is conductive, the energy stored in Ciss during the process of saturating and conducting the MOS transistor TR1 is released to the ground through TR3, thus making the MOS transistor TR1 cutoff reliably.

When the MOS transistor TR1 is cutoff, a flywheel loop is consisted of the flywheel diode D3, the feedback winding P2 and the capacitor C51. C51 is charged by the induced potential released from the feedback winding P2 on one hand, and the optical coupler OC1 is provided with the induced potential of the feedback winding P2 on the other hand.

When the energy of the primary winding P1 is dropped to a certain level, based on the principle that the current in an inductor can not be mutated, reversed electrical potential arises at the primary winding P1 to prevent the primary current from being dropped. The current gives rise to the induced electrical potential with a positive upper side and a negative lower side at the primary winding P1. Positive pulse voltage generated at the feedback winding P2 passes through the positive feedback circuit to switch on again the transistor TR1. Thus the switched power source operates in the self-excited oscillation state.

The oscillating frequency is largely determined by the inductance Lp of the transformer T1. The circuit will perform choke operation after operating with self-excitated oscillation. The transformer T1 stores energy when the MOS transistor TR1 is switched on; and outputs the energy when the MOS transistor TR1 is switched off, which is further output through the regulated voltage output loop for transfer of the energy. The output energy is provided in one branch to a load, and sampled and compared in another branch by the reference amplifier part and then input to the base of the transistor TR2 of the PFM through the optical coupler OC1 to control the current at the base of the transistor TR2, thereby adjusting the on/off time of the MOS transistor TR1 and the transistor TR2 and achieving the choke process of the circuit.

The forgoing disclosure relates to the entire operation procedure of the circuit according to the invention.

When the MOS transistor TR1 is saturated and conductive, not only the drain current Id flowing through the primary winding P1 and the MOS transistor TR1 but also the voltage drop across the resistor R4 is increased over the time.

When the voltage reaches (0.7V+V_{R3}), the transistor TR2 is switched on, and the base voltage of the transistor TR3 is dropped to thereby switch on the transistor TR3. The collector current of the transistor TR3 is increased, and the transistor TR2 is enhanced in conductivity. This loop is repeated until the transistors TR2 and TR3 are saturated.

Also since the transistor TR3 is conductive, the energy stored in Ciss during the saturation and conduction of the MOS transistor TR1 is released to the ground through the transistor TR3, the discharge time constant is very small, and the MOS transistor TR1 is switched off at a very low loss, thereby improving significantly the overall efficiency of the product.

When the circuit operates in the output short-circuit status, very large instantaneous short-circuit current gives rise to high voltage at the point Vg1, and then the MOS transistor TR1 is enhanced in conductivity, and both the drain current Id of the MOS transistor TR1 and the voltage drop across R4 is increased.

When the voltage reaches (0.7+V_{R3}) the transistor TR2 is switched on, and the base voltage of the transistor TR3 is dropped to thereby switch on the transistor TR3. The collector current of the transistor TR3 is increased, and then the transistor TR2 is enhanced in conductivity. This loop is repeated until the transistors TR2 and TR3 are saturated. Also since the transistor TR3 is conductive, the energy stored in Ciss during the saturation and conduction of the MOS transistor TR1 is released to the ground through the transistor TR3, thus making the MOS transistor TR1 cutoff reliably. The drain current Id of the MOS transistor TR1 approximates zero to thereby result in nearly zero short-circuit power consumption.

The inducted electrical potential of the transformer T1 will not be reversed until the short-circuit status comes to the end. When the current provided to the base of the transistor TR2 is below conduction current, the transistors TR2 and TR3 are switched off. The gate voltage Vg1 of the MOS transistor TR1 returns rapidly to high level, and then the MOS transistor TR1 is switched on, so that the circuit returns automatically to the normal operation mode with self-excitated oscillation, thereby achieving continuous short-circuit protection for the circuit.

Moreover the invention further improves the soft starter part. As illustrated in FIG. 3, the soft starter part is consisted of the resistor R1, the resistor R8, the capacitor C9 and the diode D2.

The input terminal VIN connected in series with the resistor R1 is grounded in one branch through the capacitor C9 and connected in another branch with the anode of the diode D2. The cathode of the diode D2 is grounded through the resistor R8 and connected in another branch with the gate of the MOS transistor.

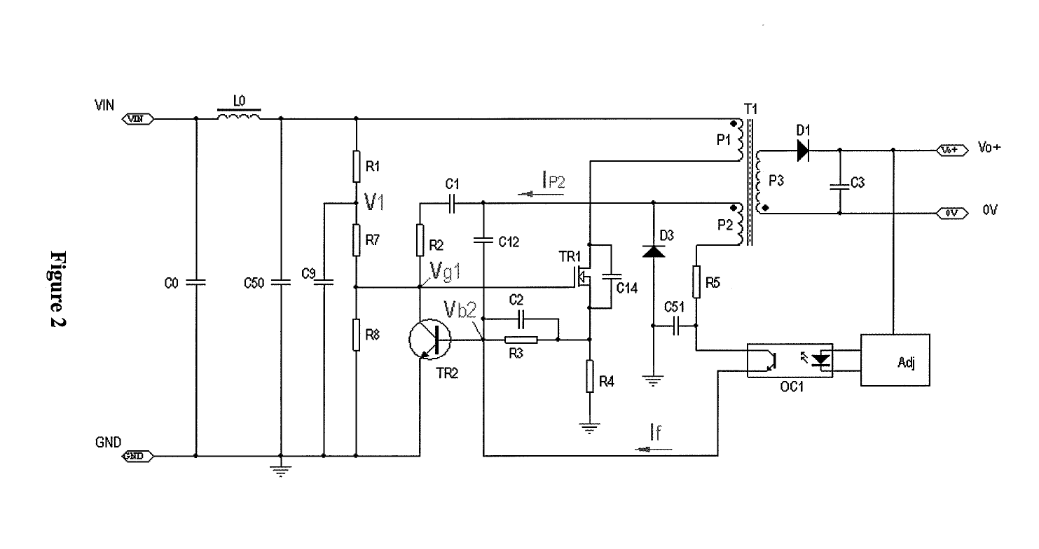

The resistor R7 in the existing circuit as illustrated in FIG. 2 is replaced with the fast recovery diode D2 in the soft starter circuit.

Generally, the fast recovery diode D2 has the conduction inner-resistance rd<<R7.

When the powered-on circuit starts to operate at t=0, the capacitor C9 is charged by the input voltage through the resistor R1, and when the voltage across C9 reaches 0.7V, the fast recovery diode D2 is switched on. Thus the internal junction capacitor Ciss of the MOS transistor TR1 starts to be charged.

When the gate threshold voltage Vth of the MOS transistor TR1 is reached, the MOS transistor TR1 is switched on. At this time, there is a charge time constant rdCgs<<R7Cgs (rd denotes the inner-resistance of the diode D2). The MOS transistor TR1 is enhanced in both the starter performance and the capability with capacitive loads.

Moreover when the potential at the point Vg1 is above that at the point V1, the current can not be reversed to flow forward due to unidirectional conductivity of the diode to thereby avoid interference of charges to a preceding circuit and improve the operation reliability of the product.

With the modified soft starter circuit, the reverse blocking characteristic of the diode can be utilized smartly to avoid interference of a drive signal generated from the positive feedback winding to the soft starter circuit and greatly improve the starter performance of the product.

In the following, respective parameters in the embodiment according to the invention illustrated in FIG. 3 will be compared experimentally with that in the implementation of the prior art illustrated in FIG. 2:

The power source is used with fundamental parameters of input DC voltage ranging from 9 to 18v and an output of 12V/500 mA. Normal operation can be performed without being loaded and with being lightly and fully loaded. The same elements are adopted in corresponding parts of the invention to those in the prior art.

As illustrated in FIG. 5, when the circuit in FIG. 2 operates in nominal full load with an output load ranging from 0 to 500 mA, the input voltage according to the invention is apparently more efficient than that of the circuit in FIG. 2 by the difference therebetween increasing as the load current is dropped.

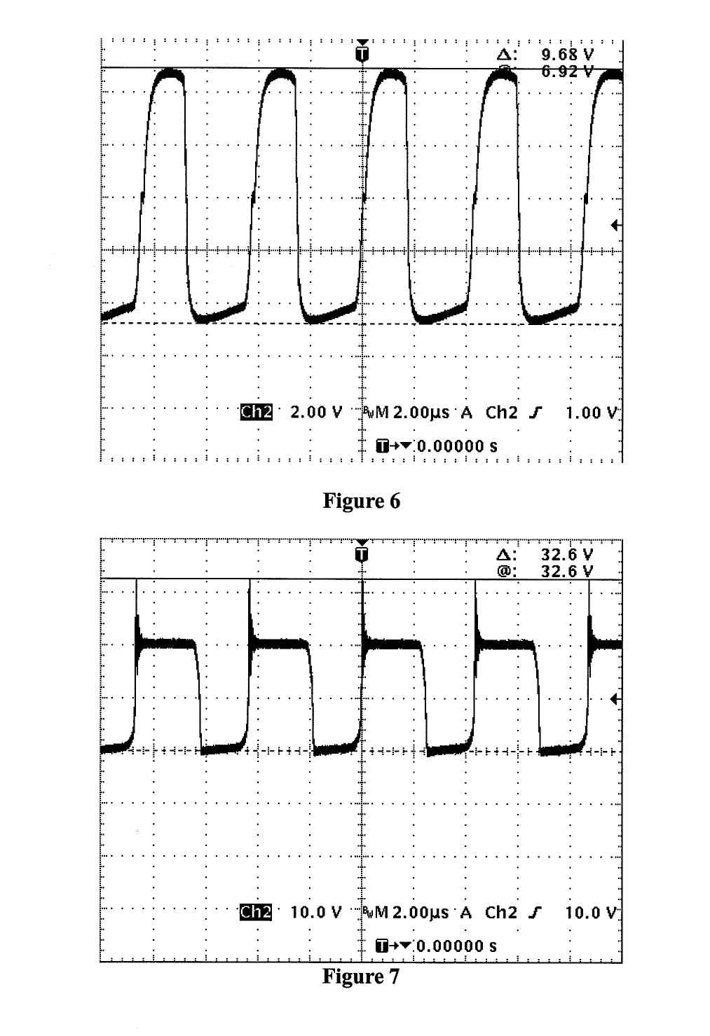

As illustrated in FIG. 5 and FIG. 6, the MOS transistor TR1 acting as a power switched transistor upon being in the stable status and nominal full load has the amplitude of its gate voltage Vg1 up to 9.62V in the circuit according to the invention, but only 5.52V in the circuit illustrated in FIG. 2.

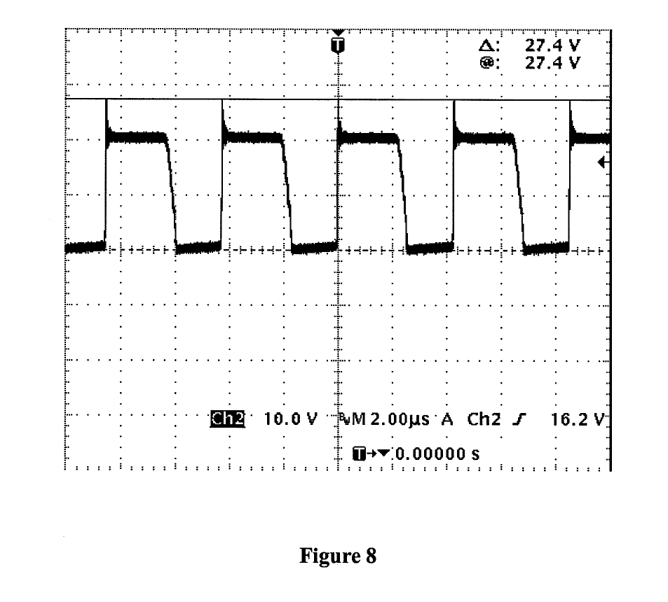

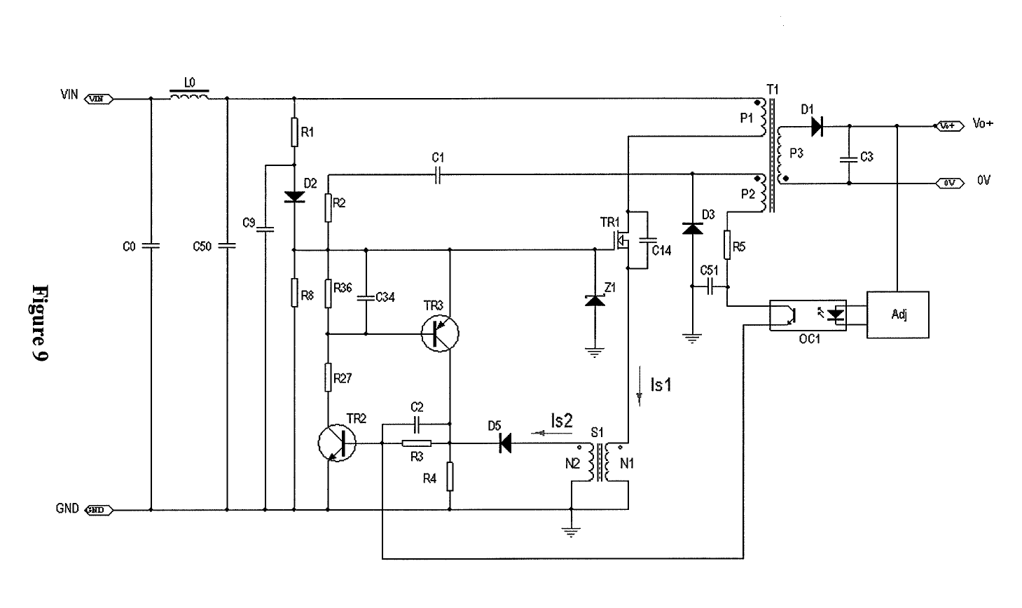

As illustrated in FIG. 7 and FIG. 8, the MOS transistor TR1 upon being in the stable status and nominal full load has the amplitude of its drain voltage Vds up to only 27.4V in the circuit according to the invention, but 32.6V in the circuit illustrated in FIG. 2 in which the device requires higher withstood voltage value.

The table below depicts other compared text indexes:

| | | Minimum input | | Nominal input | | Maximum input | |
|---|---|---|---|---|---|---|---|
| | | voltage (9 VDC) | | voltage (12 VDC) | | voltage (18 VDC) | |
| | | Uni - | Dual - | Uni - | Dual - | Uni - | Dual - |
| | | transistor | transistor | transistor | transistor | transistor | transistor |
| Test item and condition | | driven | driven | driven | driven | driven | driven |
| Full | Efficiency (%) | 76.9 | 83.9 | 78.3 | 86.6 | 74.3 | 86.9 |
| load | Linear adjusting ratio (%) | | | 0 | 0 | | |
| | (TYP) | | | | | | |
| | Load adjusting ratio (%) | | | −0.75 | −0.42 | | |
| | (TYP) | | | | | | |
| | Ripple (mV) | 20 | 15 | 10 | 10 | 10 | 10 |
| | Noise (mV) | 21.6 | 17.6 | 15 | 13 | 12 | 11 |
| | Maximum capacitive | | | 220 | 1680 | | |
| | load (uF) (TYP) | | | | | | |
| No-loaded power consumption | | 0.504 | 0.27 | 0.708 | 0.312 | 0.684 | 0.45 |
| (Mw) | | | | | | | |
| Short-circuit power consumption | | 1.0359 | 0.126 | 0.852 | 0.126 | 1.7478 | 0.198 |
| (W) | | | | | | | |
| 25%-50%-25% | Overshoot amplitude | 3.16 | 1.97 | 3.6 | 1.7 | 3.36 | 1.47 |
| Jump | (%) | | | | | | |
| | Undershoot amplitude | 3.3 | 2.13 | 3.77 | 1.87 | 3.07 | 1.6 |
| | (%) | | | | | | |
| | Recovery period (ms) | 3.26 | 3.24 | 3.27 | 3.26 | 3.27 | 3.28 |
| 50-75%-50% | Overshoot amplitude | 2.53 | 1.93 | 2.63 | 1.67 | 3.5 | 1.47 |
| Jump | (%) | | | | | | |
| | Undershoot amplitude | 2.73 | 2.03 | 2.8 | 1.83 | 3.83 | 1.57 |
| | (%) | | | | | | |
| | Recovery period (ms) | 3.27 | 3.26 | 3.26 | 3.28 | 3.27 | 3.26 |
| 10%-100%-10% | Overshoot amplitude | 10.7 | 7.08 | 10.3 | 6.17 | 12.1 | 5.13 |
| Jump | (%) | | | | | | |
| | Undershoot amplitude | 11 | 7.25 | 11 | 6.33 | 12.1 | 5.13 |
| | (%) | | | | | | |
| | Recovery period (ms) | 3.33 | 3.3 | 3.3 | 3.33 | 3.34 | 3.33 |

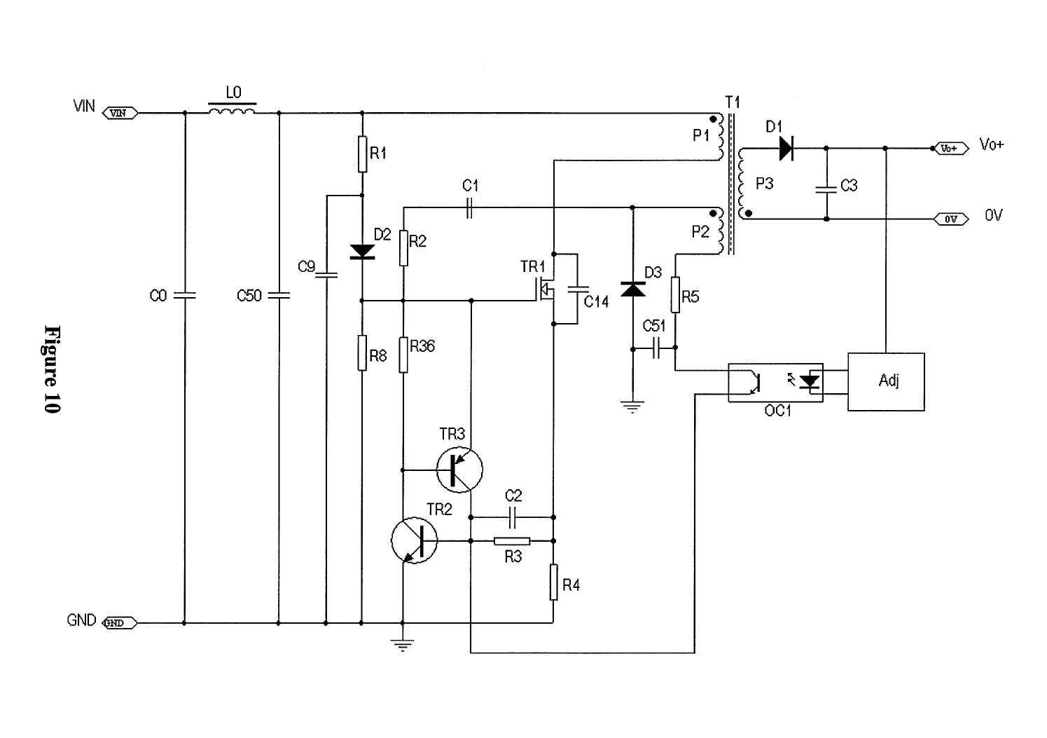

As illustrated in FIG. 9, in order to further improve the invention, based upon the embodiment illustrated in FIG. 3, the source of the MOS transistor TR1 and the resistor R4 are connected with a current mutual inductor Si and a rectifier diode D5, and the current mutual inductor Si has its primary winding N1 with the dotted terminal connected with the source of the MOS transistor TR1 and secondary winding N2 with the dotted terminal connected with the anode of the diode D5.

The cathode of the diode D5 is connected with the resistor R4, and two undotted terminals of the current mutual inductor Si are grounded.

It operates under the following principle: Is2=Is1*N1/N2 can be derived from the relationship between the turn ratio of and the current ratio of the primary to secondary windings: N1/N2=Is2/Is1.

Assumed N1=1 turn, N2=50 turns, Is1=5 A and R4=1Ω, so Is2=Is2*R4=5*1/50=0.1 A and P_{R4}=Is2²*R4=0.1²*1=0.01 W. In contrast, the power of the exiting circuit is P_{R4}=Is2²*R4=Is1²*R4=5²*1=25 W.

As can be apparent, the circuit has an advantage of the fully loaded product with very small short-circuit power consumption on the order of only 10⁻² W

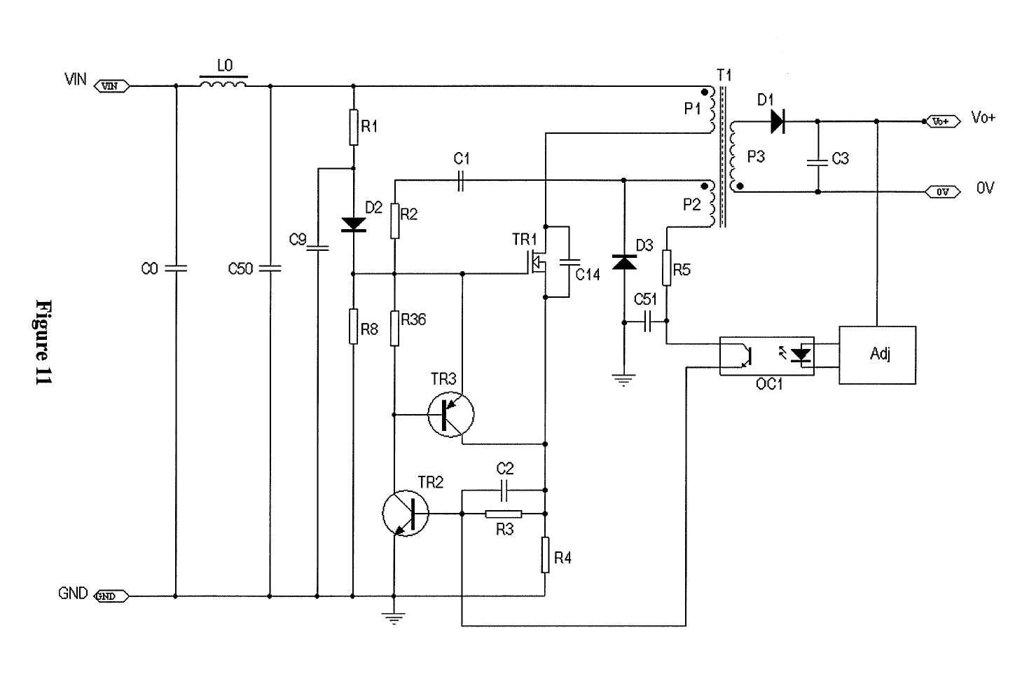

The embodiment as illustrated in FIG. 10 is substantially the same as that illustrated in FIG. 3 except for connection of the transistor TR3.

In the present embodiment, the transistor TR3 has its emitter connected with the gate of the MOS transistor TR1, base connected in one branch with the gate of the MOS transistor TR1 through a bias resistor R36 and in another branch with the collector of the transistor TR2, and collector connected with the base of the transistor TR2.

The base of the transistor TR2 is connected with the source of the MOS transistor TR1 through the bias resistor R3.

The capacitor C2 is connected in parallel across the resistor R3.

The source of the MOS transistor TR1 is grounded through the resistor R4.

Also in the embodiment illustrated in FIG. 10, the current mutual inductor Si and the rectifier diode D5 can be connected between the source of the MOS transistor TR1 and the resistor R4 to attain the same effect.

The embodiment as illustrated in FIG. 11 is substantially the same as that illustrated in FIG. 3 except for connection of the transistor TR3.

In the present embodiment, the transistor TR3 has its emitter connected with the gate of the MOS transistor TR1, base connected in one branch with the gate of the MOS transistor TR1 through a bias resistor R36 and in another branch with the collector of the transistor TR2, and collector connected with the source of the MOS transistor TR1.

The source of the MOS transistor TR1 is connected with the base of the transistor TR2 through the bias resistor R3.

The capacitor C2 is connected in parallel across the resistor R3.

The source of the MOS transistor TR1 is grounded through the resistor R4.

Also in the embodiment illustrated in FIG. 11, the current mutual inductor Si and the rectifier diode D5 can be connected between the source of the MOS transistor TR1 and the resistor R4 to attain the same effect.

1. A current controlled ring choke converter with dual-transistor, comprising a soft starter part, a MOS transistor, a transformer, a Pulse Frequency Modulation part, a reference amplifier part, an isolating optical coupler OC1 and a regulated voltage output loop part, wherein:
input electric quantity is connected with the output loop part through the MOS transistor;
the soft starter part is connected with the gate of the MOS transistor;
the gate of the MOS transistor is further connected with the Pulse Frequency Modulation part;
the reference amplifier part and the isolating optical couple are connected between the Pulse Frequency Modulation part and the regulated voltage output loop part to form a voltage negative feedback loop; and
the Pulse Frequency Modulation part generally comprises a second transistor, a first resistor, a capacitor and a second resistor, the base of the second transistor is connected with the source of the MOS transistor through the first resistor and a first capacitor connected in parallel, and the source of the MOS transistor is grounded through the second resistor, wherein the Pulse Frequency Modulation part is further provided with a transistor current control circuit connected between the MOS transistor and the second transistor to enable a self-excitated oscillation output of dual-transistor current control at an input terminal.

2. The current controlled ring choke converter with dual-transistor according to claim 1, wherein the transistor current control circuit comprises a third transistor and a third resistor;
the third transistor has an emitter connected with the gate of the MOS transistor, a base connected in one branch with the gate of the MOS transistor through the third resistor and in another branch with the collector of the second transistor, and a collector connected with the base of the second transistor;
the base of the second transistor is connected with the source of the MOS transistor through the first resistor R3; and
the source of the MOS transistor is grounded through the second resistor.

3. The current controlled ring choke converter with dual-transistor according to claim 1, wherein the transistor current control circuit comprises a third transistor and a third resistor;
the third transistor has an emitter connected with the gate of the MOS transistor, a base connected in one branch with the gate of the MOS transistor through the third resistor and in another branch with the collector of the second transistor, and a collector connected with the source of the MOS transistor;
the source of the MOS transistor is connected with the base of the second transistor through the first resistor; and
the source of the MOS transistor is grounded through the second resistor.

4. The current controlled ring choke converter with dual-transistor according to claim 1, wherein the transistor current control circuit comprises a third transistor, a third resistor and a fourth resistor;
the third transistor has an emitter connected with the gate of the MOS transistor, a base connected in one branch with the gate of the MOS transistor through the third resistor and in another branch with the collector of the second transistor through the fourth resistor, and a collector connected with the source of the MOS transistor;
the source of the MOS transistor is connected with the base of the second transistor through the first resistor; and
the source of the MOS transistor is grounded through the second resistor.

5. The current controlled ring choke converter with dual-transistor according to claim 2, wherein a current mutual inductor and a flywheel diode are connected between the source of the MOS transistor and the second resistor;
a primary dotted terminal of the current mutual inductor is connected with the source of the MOS transistor;
a secondary dotted terminal of the current mutual inductor is connected with the anode of the diode;
the cathode of the diode is connected with the second resistor; and
two undotted terminals of the current mutual inductor are grounded.

6. The current controlled ring choke converter with dual-transistor according to claim 5, wherein a second capacitor is connected in parallel across the third resistor, and the first capacitor is connected in parallel across the first resistor.

7. The current controlled ring choke converter with dual-transistor according to claim 6, wherein the MOS transistor is of the N channel type, the second transistor is of the NPN type, and the third transistor is of the PNP type.

8. The current controlled ring choke converter with dual-transistor according to claim 7, wherein the gate of the MOS transistor is connected with a regulated voltage diode; and
the regulated voltage diode has a cathode connected with the gate of the MOS transistor and an anode grounded.

9. The current controlled ring choke converter with dual-transistor according to claim 1, wherein the soft restart circuit is consisted of a third resistor, a fourth resistor, a second capacitor and a diode;
the input terminal connected in series with the third resistor is grounded in one branch through the second capacitor and connected in another branch with the anode of the diode; and
the cathode of the diode is grounded in one branch through the fourth resistor and connected in another branch with the gate of the MOS transistor.

10. The current controlled ring choke converter with dual-transistor according to claim 9, wherein the diode is a fast recovery diode.

11. The current controlled ring choke converter with dual-transistor according to claim 3, wherein a current mutual inductor and a flywheel diode are connected between the source of the MOS transistor and the second resistor;
a primary dotted terminal of the current mutual inductor is connected with the source of the MOS transistor;
a secondary dotted terminal of the current mutual inductor is connected with the anode of the diode;
the cathode of the diode is connected with the second resistor; and
two undotted terminals of the current mutual inductor are grounded.

12. The current controlled ring choke converter with dual-transistor according to claim 11, wherein a second capacitor is connected in parallel across the third resistor, and the first capacitor is connected in parallel across the first resistor.

13. The current controlled ring choke converter with dual-transistor according to claim 12, wherein the MOS transistor is of the N channel type, the second transistor is of the NPN type, and the third transistor is of the PNP type.

14. The current controlled ring choke converter with dual-transistor according to claim 13, wherein the gate of the MOS transistor is connected with a regulated voltage diode; and
the regulated voltage diode has a cathode connected with the gate of the MOS transistor and an anode grounded.

15. The current controlled ring choke converter with dual-transistor according to claim 4, wherein a current mutual inductor and a flywheel diode are connected between the source of the MOS transistor and the second resistor;
a primary dotted terminal of the current mutual inductor is connected with the source of the MOS transistor;
a secondary dotted terminal of the current mutual inductor is connected with the anode of the diode;
the cathode of the diode is connected with the second resistor; and
two undotted terminals of the current mutual inductor are grounded.

16. The current controlled ring choke converter with dual-transistor according to claim 15, wherein a second capacitor is connected in parallel across the third resistor, and the first capacitor is connected in parallel across the first resistor.

17. The current controlled ring choke converter with dual-transistor according to claim 16, wherein the MOS transistor is of the N channel type, the second transistor is of the NPN type, and the third transistor is of the PNP type.

18. The current controlled ring choke converter with dual-transistor according to claim 17, wherein the gate of the MOS transistor is connected with a regulated voltage diode; and
the regulated voltage diode has a cathode connected with the gate of the MOS transistor and an anode grounded.
